(19) United States
(12) Patent Application Publication
(10) Pub. No.: US 2009/0200790 A1
(43) Pub. Date: Aug. 13, 2009

(54) AUTHENTICITY PROOF LABEL AND METHOD OF PREVENTING UNAUTHORIZED USE OF AUTHENTICITY PROOF LABEL

(75) Inventors: Masayoshi Kanno, Kanagawa (JP); Akira Shirakura, Tokyo (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/355,425

(22) Filed: Jan. 16, 2009

(30) Foreign Application Priority Data
Feb. 13, 2008 (JP) 2008-032177

(51) Int. Cl. G09F 3/10; B42D 15/00

(52) U.S. Cl. 283/67; 40/638; 40/675; 283/72

(57) ABSTRACT

An authenticity proof label is provided and includes an adhesive layer, a hologram layer provided on the adhesive layer, a protective layer provided on the hologram layer, and a cut provided from a side of the protective layer in such a manner as to at least reach the hologram layer, the cut dividing a surface area of the protective layer into at least two segments.

### CROSS REFERENCES TO RELATED APPLICATIONS

The present application claims priority to Japanese Patent Application JP 2008-032177 filed in the Japanese Patent Office on Feb. 13, 2008, the entire contents of which is incorporated herein by reference.

### BACKGROUND

In recent years, there has been a major problem in that many forged products called copies or pirated products are being sold. Therefore, an increasing number of products are mounted with authenticity proof labels for proving their authenticity. As an example of authenticity proof labels, a hologram obtained by using an embossing die, or the like is known in general. An embossed hologram has on a surface thereof a fine concave-convex pattern. When rays of light reflected by the concave-convex pattern interfere with each other, a solid image is constructed.

Japanese Unexamined Patent Application Publication No. 10-86176 discloses a hologram card including an embossed hologram and a method of manufacturing the same, in which formation of an embossed hologram to be provided on a credit card or an identification card is performed simultaneously with formation of the card in an injection step included in a card molding process. According to this process, occurrence of projections and depressions that have been seen in a portion having the hologram in the related-art because the hologram has been pasted on the card surface can be prevented, and the appearance of the card can be improved. Moreover, since the hologram is provided in the card surface integrally with the card, acts of dishonesty such as alteration to the hologram can be prevented.

However, there has been a problem in such an authenticity proof label including an embossed hologram that a forged label can be made easily by transferring the concave-convex pattern on the surface of the label. Therefore, acts of copying the authenticity proof label itself pasted on a card or the like for prevention of forgery, and pasting of such a copy to another product have arisen.

To prevent such acts, another proposal has been made in which a thick hologram (hereinafter called a volume hologram) that is more difficult to copy is used as an authenticity proof label. In the volume hologram, a change in the refractive index occurring within the label, not the surface concave-convex pattern, is utilized, whereby images can be multiplied together. Therefore, an authenticity proof label including the volume hologram is very difficult to copy. Accordingly, forgery can be prevented.

Although an authenticity proof label including the volume hologram is difficult to copy, there may be a possibility of unauthorized use in which the authenticity proof label pasted on a product is removed and is pasted onto a forged product. To prevent such unauthorized use by removing an authenticity proof label once that has been pasted onto a product, a countermeasure is currently taken in which, for example, the authenticity proof label is made to be easily torn when removed, by providing cuts at four corners thereof.

With the cuts provided in the authenticity proof label, it has become difficult to remove the label without any know-how. This has suppressed forgery to some extent. However, complete prevention of the unauthorized use of the authenticity proof label has been difficult. That is, with an authenticity proof label including a volume hologram, although copying of the authenticity proof label itself can be prevented, it is difficult to completely prevent the act of forgery made by removing the authenticity proof label itself for unauthorized use.

### SUMMARY

In light of the above, the present application provides an authenticity proof label with which copying and unauthorized use of the authenticity proof label can be prevented and a method of preventing unauthorized use of an authenticity proof label.

The present application relates to authenticity proof labels that prevents copying and unauthorized use thereof, and methods of preventing unauthorized use of authenticity proof labels.

According to a first embodiment, an authenticity proof label includes an adhesive layer, a hologram layer provided on the adhesive layer, a protective layer provided on the hologram layer, and a cut provided from a side of the protective layer in such a manner as to at least reach the hologram layer, the cut dividing a surface area of the protective layer into at least two segments.

Since the authenticity proof label according to the first embodiment is provided with the cut, fragility is given to the authenticity proof label. The cut is desired to at least reach the hologram layer. Alternatively, the cut may reach the adhesive layer. The deeper the cut, the larger the fragility given to the authenticity proof label. In the first embodiment, the fragility given to the authenticity proof label means, for example, easiness of being damaged when the authenticity proof label is removed from the base member.

Further, the authenticity proof label according to the first embodiment may have the segments resulting from the division by providing the cut each connected to the other at a part thereof. The “part” in this case is of a size sufficient to maintain the aforementioned fragility given to the authenticity proof label.

Thus, with the authenticity proof label according to the first embodiment, unauthorized use of the authenticity proof label itself can be prevented.

According to a second embodiment, a method of preventing unauthorized use of an authenticity proof label includes the steps of preparing an authenticity proof label including an adhesive layer, a hologram layer provided on the adhesive layer, and a protective layer provided on the hologram layer; pasting the authenticity proof label onto a base member; and providing a cut with a predetermined depth from a side of the protective layer in such a manner that a surface area of the protective layer of the authenticity proof label after the pasting is divided into at least two segments.

In the method of preventing unauthorized use of an authenticity proof label according to the second embodiment, the cut is provided in the authenticity proof label after the authenticity proof label is pasted onto the base member. Therefore, at the time that the authenticity proof label is pasted onto the base member, the authenticity proof label does not have fragility. However, since fragility is given to the authenticity proof label when the cut is provided therein, the authenticity proof label is easily damaged when removed from the base member.

Further, the cut is desired to at least reach the hologram layer, and may reach the base member.

In the method of preventing unauthorized use of an authenticity proof label according to the second embodiment, the cut may be provided in such a manner that the segments to be divided are each connected to the other at a part thereof. The “part” in this case is of a size sufficient to maintain the aforementioned fragility given to the authenticity proof label.

Thus, by the method of preventing unauthorized use of an authenticity proof label according to the second embodiment, unauthorized use of the authenticity proof label itself can be prevented.

Additional features and advantages are described herein, and will be apparent from the following Detailed Description and the figures.

### BRIEF DESCRIPTION OF THE FIGURES

FIGS. 1A and 1B are a schematic diagram and a cross-sectional view of an authenticity proof label according to a first embodiment;

FIGS. 2A, 2B, and 2C show steps included in a method of preventing unauthorized use of the authenticity proof label according to the first embodiment;

FIG. 3 is a schematic diagram of the authenticity proof label in which a cut is provided;

FIGS. 4A, 4B, and 4C show other examples of the cut provided in the authenticity proof label;

FIGS. 5A and 5B are a schematic diagram and a cross-sectional view of an authenticity proof label according to a second embodiment; and

FIGS. 6A, 6B, and 6C show other examples of the cut provided in the authenticity proof label.

### DETAILED DESCRIPTION

Embodiments will now be described with reference to the drawings

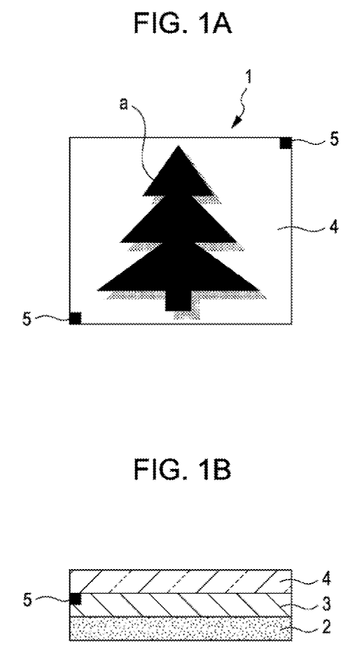

A first embodiment will be described with reference to FIGS. 1A to 4C. First, referring to FIGS. 1A and 1B, the schematic configuration of an authenticity proof label according to the first embodiment will be described. FIG. 1A is a schematic plan view of an authenticity proof label 1 in the first embodiment. FIG. 1B is a schematic cross-sectional view of the authenticity proof label 1.

The authenticity proof label 1 in the first embodiment includes an adhesive layer 2 composed of acrylic adhesive or the like, a hologram layer 3 provided on the adhesive layer 2 and composed of a holographic material, and a protective layer 4 provided on the hologram layer 3 and composed of transparent resin film or the like. The authenticity proof label 1 of the first embodiment is a volume hologram. The hologram layer 3 has an object a that is three-dimensionally recorded therein. The image of the object a is displayed as shown in FIG. 1A.

The three-dimensional recording of the object a into the hologram layer 3 is performed by causing an object beam having information on a desired object and a reference beam of the same wavelength as the object beam to be incident on the hologram layer 3 and recording interference fringes resulting from the interference between the object beam and the reference beam as a change in the refractive index of the hologram layer 3.

For example, in the first embodiment, an object beam having information on the object a and a reference beam having the same wavelength as the object beam are caused to be incident on the hologram layer 3. In response to this, the object beam and the reference beam interfere with each other, producing interference fringes. The interference fringes are recorded into the hologram layer 3, whereby the information on the object a is recorded into the hologram layer 3. In this manner, a reproduced image of the object a is displayed on the hologram layer 3 in which the information on the object a is recorded.

In a case where a volume hologram is formed, it is important that the materials of the adhesive layer 2 and the protective layer 4 have optical characteristics that exhibit a small light-scattering amount, a small birefringence amount, a high light transmittance, and so forth. As the holographic material of the hologram layer 3, a material having a high resolution is used. For example, a DuPont product named “OMNI-DEX” can be used. This holographic material is composed of photopolymer, in the initial state of which monomers are evenly dispersed in a matrix polymer. When the photopolymer in such a state is irradiated with light having a power of about 10 to 400 mJ/cm2, monomers in a region that have been exposed to the light are polymerized in accordance with the power of the light applied thereto. As a result, variations in concentration of monomers occur with positions, causing modulation of the refractive index. Subsequently, by applying ultraviolet light having a power of about 1000 mJ/cm2, for example, to the entirety of the foregoing material, polymerization of the monomers is completed and the degree of refractive-index modulation is increased. Thus, the refractive index is fixed at the modulated value.

The authenticity proof label 1 including a volume hologram is excellent in terms of design. Further, since three-dimensional recording is performed utilizing a change in the refractive index of the hologram layer 3, the surface of the protective layer 4 is flat, making copying or forgery of the authenticity proof label 1 more difficult than in the case of an embossed hologram.

Further, the authenticity proof label 1 in the first embodiment has positioning marks 5, which are to be used in a subsequent step, in part of the hologram layer 3, for example, at two diagonal corners. The positioning marks 5, which are provided in the hologram layer 3 in the first embodiment, may be alternatively provided in part of the protective layer 4, for example. In the case where the positioning marks 5 are provided in the hologram layer 3, since provision of the positioning marks 5 can be performed simultaneously with recording of image information into the hologram layer 3, the number of manufacturing steps will not be increased.

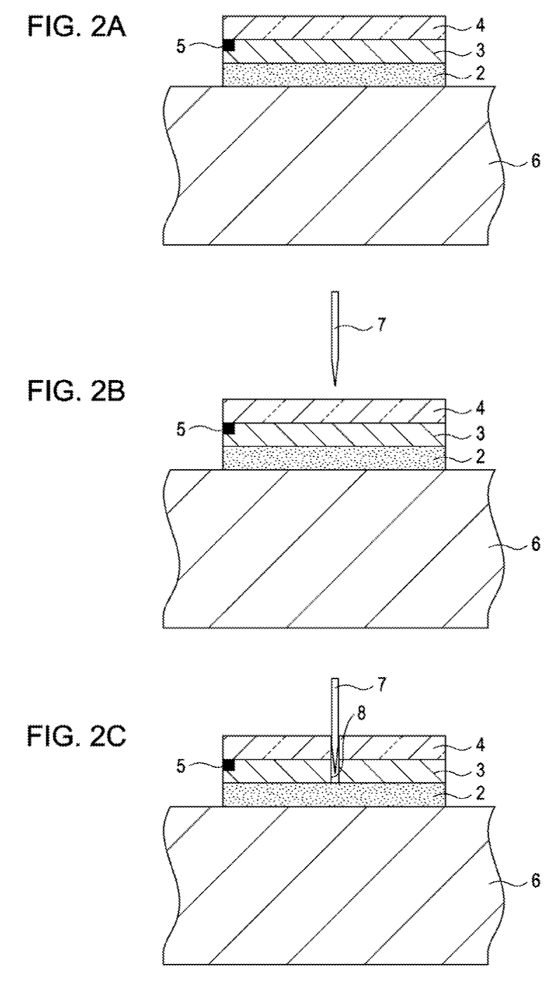

Next, referring to FIG. 2, a method of preventing unauthorized use of an authenticity proof label according to the first embodiment will be described.

First, the authenticity proof label 1 shown in FIG. 1 is pasted onto a desired base member 6, as shown in FIG. 2A. Typical exemplary materials of the base member 6 include plastic, vinyl, and the like. Pasting of the authenticity proof label 1 onto the base member 6 may be performed either by using a machine in such a manner as to paste the authenticity proof label 1 to a predetermined position on the base member 6, or by hand.

Subsequently, referring to FIG. 2B, relative positioning between a cutter 7, which is included in a dividing device (not shown) for making a cut, and the authenticity proof label 1 is performed before the surface area of the protective layer 4 of the authenticity proof label 1 is divided by providing a cut in the authenticity proof label 1. The positioning is performed with reference to the positioning marks 5 provided in the hologram layer 3. With the positioning marks 5, the position of the cutter 7 of the dividing device is determined.

In the first embodiment, the cut is provided in such a manner that the surface area of the protective layer 4 is divided into two segments, and the cut, which forms the boundary between the two segments, is provided in a wavy line.

Referring to FIG. 2C, after the positioning of the cutter 7, the cutter 7 that has been positioned is pressed down from the side of the protective layer 4 of the authenticity proof label 1 to a predetermined depth of the authenticity proof label 1, whereby the surface area of the protective layer 4 is divided into two segments. In the first embodiment, a cut 8 extending through the hologram layer 3 in the depth direction of the authenticity proof label 1 is provided by using the cutter 7.

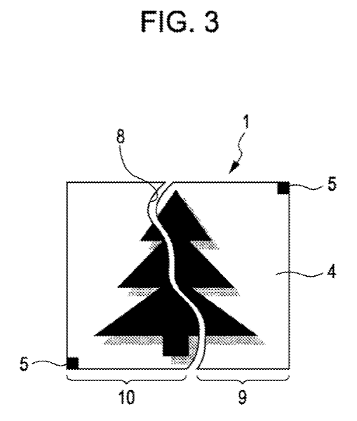

FIG. 3 is a schematic top view of the authenticity proof label 1 of the first embodiment in which the cut 8 is provided in such a manner as to divide the surface area of the protective layer 4 into two segments 9 and 10. In the first embodiment, the cut 8 is provided in such a form as to divide the image of the object a that is recorded in the hologram layer 3 into two. Specifically, displayed information (the object a) of the authenticity proof label 1 is divided along a dividing line provided as the cut 8. Further, as described above, the cut 8 is provided in a wavy line.

In the first embodiment, to retain the design feature of the displayed image of the divided object a in the same way as before the division, it is important to prepare the authenticity proof label 1 on the premise that the authenticity proof label 1 is to be divided, and to appropriate display the image of the authenticity proof label 1 before and after the division.

Specifically, it is important that the authenticity proof label 1 in the first embodiment be made of a material and have a thickness such that the authenticity proof label 1 is easy to divide but dividing does not result in damage thereof, and have a material composition realizing an assuredly durable surface, which is to be divided.

Further, in the first embodiment, the cut 8 is provided after the authenticity proof label 1 is pasted onto the base member 6. At this time, fragility is given to the authenticity proof label 1.

If it is attempted to remove from the base member 6 the authenticity proof label 1 that has been pasted onto the base member 6 and in which the cut 8 extending through the hologram layer 3 has been provided as described above in such a manner that the surface area of the protective layer 4 is divided, the relative positions of the two divided segments 9 and 10 will change or the authenticity proof label 1 will be deformed. That is, since fragility has been given to the authenticity proof label 1 by the cut 8, the authenticity proof label 1 is easily damaged if it is attempted to remove the authenticity proof label 1 from the base member 6.

In a case where the size of the cut 8 is small relative to the surface area of the protective layer 4, the fragility given to the authenticity proof label 1 at the time of removal thereof is not so great. In contrast, in the first embodiment, the surface area of the protective layer 4 is completely divided by the cut 8 into the two segments 9 and 10. Therefore, it is difficult to remove the authenticity proof label 1 without changing the relative positions of the two segments 9 and 10. Moreover, if the authenticity proof label 1 of the first embodiment is removed from the base material 6 and is pasted onto another base member that is forged, the relative positions of the two segments 9 and 10 will change further. If the relative positions of the two segments 9 and 10 change, the image recorded in the hologram layer 3 will not be appropriately reproduced. That is, if the image is not appropriately displayed, it can be visually identified that the product is a forgery.

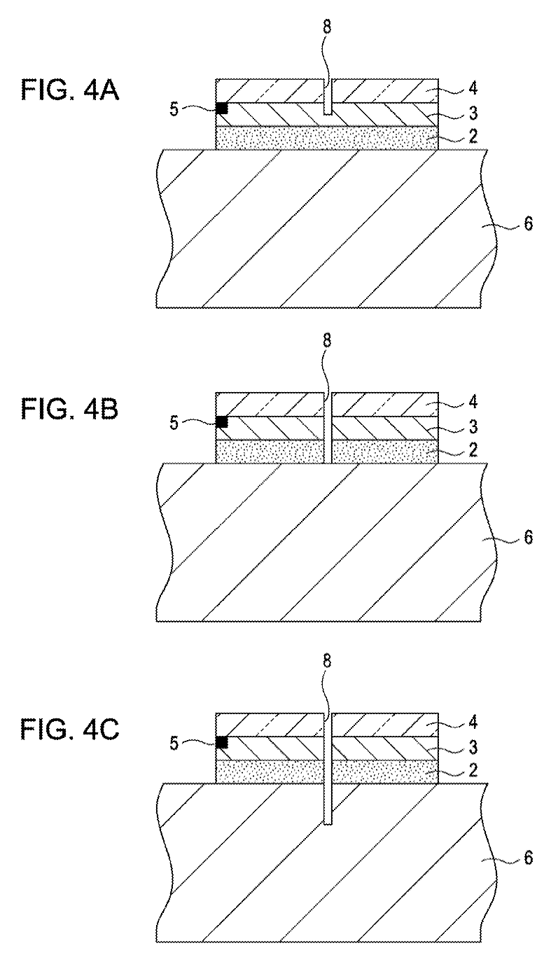

Although the first embodiment concerns the case where the cut 8 is provided with such a depth that the hologram layer 3 is divided, the cut 8 is only desired to have a depth sufficient to give fragility causing the hologram layer 3 to be torn when it is attempted to remove the authenticity proof label 1 from the base member 6. Specifically, as an exemplary case shown in FIG. 4A, the cut 8 may be provided in such a manner as to reach the hologram layer 3. As an alternative case shown in FIG. 4B, the cut 8 may be provided through the adhesive layer 2. As another alternative case shown in FIG. 4C, the cut 8 may be provided in such a manner as to reach the base member 6. Thus, the depth of the cut 8 can be set in the dividing device and, in accordance with the set value, the depth with which the cutter 7 makes the cut is determined.

For example, if the authenticity proof label 1 having the cut 8 reaching the base member 6 is removed from the base member 6 and is attempted to be pasted thereonto again, alignment between the position of the cut 8 in the base member 6 and the dividing position of the authenticity proof label 1 is very difficult. This makes forging more difficult.

Further, if the base member 6 is not a casing made of a plastic material but, for example, a film-like flexible material having fragility, damage to the base member 6 itself will also be added. Therefore, if the authenticity proof label 1 of the first embodiment is removed from the base member 6 having fragility, the relative positions of the divided segments 9 and 10 change more easily.

Now, if an authenticity proof label is provided with a cut that divide the authenticity proof label into two segments before the authenticity proof label is pasted onto a base member as an authentic product, the authenticity proof label will have fragility before being pasted onto the base member. In such a case, the relative positions of the divided segments will change at the time that the authenticity proof label is pasted onto the base member as an authentic product. Specifically, if a cut is provided before the authenticity proof label is pasted onto a base member, the authenticity proof label will not be pasted appropriately even if the base member is an authentic product. Without cost and know-how of a dedicated pasting device and the like, it is impractically difficult to appropriately paste such an authenticity proof label in which a cut is provided in advance onto a base member.

In contrast, in the method of preventing unauthorized use of an authenticity proof label of the first embodiment, the cut 8 is provided after the authenticity proof label 1 is pasted onto the base member 6. Thus, when the authenticity proof label 1 is pasted onto the base member 6 as an authentic product, the relative positions of the segments 9 and 10 do not change. That is, the authenticity proof label 1 can be pasted easily in quite the same manner as of the related-art label pasting. However, by providing the cut 8 after the pasting, the relative positions of the segments 9 and 10 are caused to change at the time of removal of the authenticity proof label 1 from the base member 6 as an authentic product. Thus, the authenticity proof label 1 of the first embodiment is advantageous in that the authenticity proof label 1 can be pasted onto the base member 6, as an authentic product, with high accuracy, and that unauthorized use of the authenticity proof label 1 once that has been used can be prevented.

According to the method of preventing unauthorized use of an authenticity proof label in the first embodiment, since fragility is given to the authenticity proof label 1 after the authenticity proof label 1 is pasted onto the base member 6, if the authenticity proof label 1 is removed and is pasted for the purpose of unauthorized use, the relative positions of the two divided segments 9 and 10 change. In this manner, unauthorized use, i.e., secondary use, of the authenticity proof label 1 can be prevented.

Although the cut 8 in the first embodiment is provided in a wavy line, the configuration is not limited thereto and can be provided in various forms. In the first embodiment, with the cut 8 in a wavy line, the authenticity proof label 1 becomes more difficult to remove from the base member 6, and the effect of preventing unauthorized use can be enhanced. Further, although the first embodiment concerns the case of division into the two segments 9 and 10, the configuration is not limited thereto and division into more than two segments is also acceptable. As the number of divided segments increases, the difficulty in making unauthorized use increases.

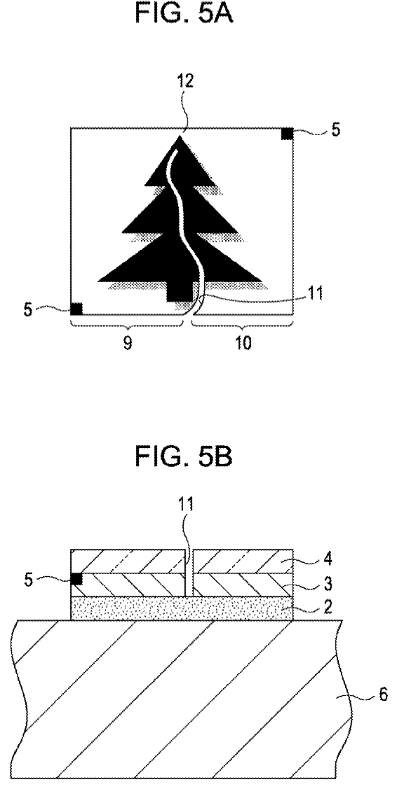

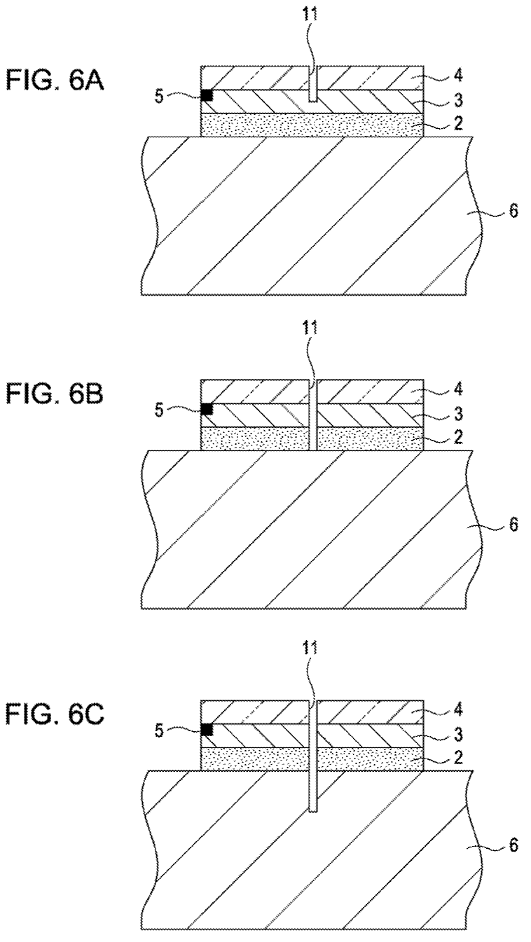

Next, a second embodiment will be described with reference to FIGS. 5A to 6C. The second embodiment partially differs from the first embodiment in the configuration of the cut.

In FIGS. 5A to 6C, elements corresponding to those in FIGS. 1A to 4C are denoted by the same reference numerals and redundant descriptions thereof are omitted.

FIGS. 5A and 5B are a schematic diagram and a cross-sectional view of an authenticity proof label of the second embodiment. The second embodiment concerns an exemplary case where the authenticity proof label 1 has a cut 11 provided through the same steps as those shown in FIGS. 2A to 2C. However, the cut 11 provided in the second embodiment does not completely divide the surface area of the protective layer 4 into the segments 9 and 10. Specifically, referring to FIG. 5A, a connecting portion 12 that connects the divided segments 9 and 10 to each other at a part thereof is provided.

Also in the second embodiment, referring to FIG. 5B, the cut 11 extends through the hologram layer 3 in the depth direction thereof.

The cut 11 provided in the authenticity proof label 1 of the second embodiment does not completely divide the surface area of the protective layer 4. However, fragility sufficient to change the relative positions of the divided segments 9 and 10 of the authenticity proof label 1 if it is attempted to remove the authenticity proof label 1 from the base member 6 can be given to the authenticity proof label 1. Also in the second embodiment, the cut 11 may be provided in such a manner as to reach the hologram layer 3 as shown in FIG. 6A, to extend through the adhesive layer 2 as shown in FIG. 6B, or to reach the base member 6 as shown in FIG. 6C.

As described above, the connecting portion 12 that connects the segments 9 and 10, which are to be divided, to each other at a part thereof may be provided as long as fragility given by the cut 11 to the authenticity proof label 1 can be maintained. Specifically, the cut is desired to maintain the capability sufficient to cause the authenticity proof label 1 to be damaged by an external force applied thereto at the removal thereof from the base member 6 or an external force applied thereto at the pasting thereof for the purpose of unauthorized use, or, even if the authenticity proof label 1 is not damaged, to cause the relative positions of the divided segments 9 and 10 to change. The width of the connecting portion 12 in a direction orthogonal to the connecting direction thereof can be made sufficiently smaller than the length of the cut 1 1.

To summarize, when an authenticity proof label is pasted on a base member as an authentic product, the authenticity proof label has not been given fragility yet and therefore can be appropriately pasted onto the base member. Further, by subsequently providing a predetermined cut, fragility leading to damage, deformation, and the like is given to the authenticity proof label at the removal thereof from the base member. In this manner, secondary use of the authenticity proof label can be prevented.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An authenticity proof label comprising:
an adhesive layer;
a hologram layer provided on the adhesive layer;
a protective layer provided on the hologram layer; and
a cut provided from a side of the protective layer in such a manner as to at least reach the hologram layer, the cut dividing a surface area of the protective layer into at least two segments.

2. The authenticity proof label according to claim 1, wherein the hologram layer is a thick hologram layer.

3. The authenticity proof label according to claim 1, wherein the at least two segments are each connected to the other at a part thereof.

4. The authenticity proof label according to claim 1, wherein the hologram layer or the protective layer has in part thereof a positioning mark used for positioning of the cut.

5. A method of preventing unauthorized use of an authenticity proof label, the method comprising:
preparing an authenticity proof label including an adhesive layer, a hologram layer provided on the adhesive layer, and a protective layer provided on the hologram layer;
pasting the authenticity proof label onto a base member; and
providing a cut with a predetermined depth from a side of the protective layer in such a manner that a surface area of the protective layer of the authenticity proof label after the pasting is divided into at least two segments.

6. The method of preventing unauthorized use of an authenticity proof label according to claim 5, wherein the hologram layer is a thick hologram layer.

7. The method of preventing unauthorized use of an authenticity proof label according to claim 5, further comprising:
determining, before providing the cut, a position where the cut is provided, with reference to a positioning mark provided in the hologram layer or the protective layer.

8. The method of preventing unauthorized use of an authenticity proof label according to claim 5, wherein the cut is provided in such a manner that the at least two segments are each connected to the other at a part thereof.

9. The method of preventing unauthorized use of an authenticity proof label according to claim 5, wherein the cut is provided in such a manner as to reach the base member.
